(19) United States
(12) Patent Application Publication
(10) Pub. No.: US 2006/0246414 A1
(43) Pub. Date: Nov. 2, 2006

(54) Method for microdrop vitrification of cells

(75) Inventors: Chia-Chieh Chang, Taitung Hsien (TW); Jan-Chi Huang, Pingtung Hsien (TW); Perng-Chih Shen, Tainan (TW)

Correspondence Address: NIKOLAI & MERSEREAU, P.A., 900 SECOND AVENUE SOUTH, SUITE 820, MINNEAPOLIS, MN, 55402, US

(73) Assignee: LIVESTOCK RESEARCH INSTITUTE, COUNCIL OF AGRICULTURE, Tainan (TW)

(21) Appl. No.: 11/116,703

(22) Filed: Apr. 28, 2005

(51) Int. Cl. A01N 1/02

(52) U.S. Cl. 435/2

(57) ABSTRACT

The present invention relates to a method for microdrop vitrification of cells comprising providing cells, culturing the cells in a culture medium containing cryoprotectants for a short period, forming a microdrop from the culture medium containing the cells, and contacting the microdrop with liquid nitrogen to obtain a glass-like bead.

### BACKGROUND OF THE INVENTION

1. Field of the Invention

The present invention relates to a method for microdrop vitrification of cells.

2. Description of Related Art

Advancements in the cryopreservation of oocytes and embryos have been achieved by using traditional slow-rates freezing technique, straws vitrification, open pulled straws vitrification and microdrops vitrification. The freezing techniques play a crucial role in reproductive biology and assist in reproduction techniques.

Bilton and Moore first reported the birth of lambs on the successful application of the slow-rates freezing technique for goat embryos in 1976. 1.5 Methylene glycol is a quite universal cryoprotectant to goat embryos, and the slow-rate freezing technique has become very well established (Huang et al., 1997; Gayar and Holtz, 2001; Cognie et al., 2003). Procedures that are currently used for the cryopreservation of goat embryos rely on slow-rates freezing technique. These methods are reliable, but they often require expensive equipment, furthermore, they are time-consuming and inconvenient to operate under field conditions.

To improve the slow-rate freezing technique, various methods have been described in attempts to increase the cooling rate and reduce the cost of the apparatus, and the vitrification technique is one of those methods. In 1985, the vitrification technique was developed for mouse embryos. The first successful transfer of vitrified goat embryos was reported by Yuswiati and Holtz (1990). Currently, different vitrification methods have been proposed but the survival rate is still low. In addition, to stepwise increase concentration of vitrification solution during manipulation and to fill a straw with cryoprotectant are both complicated in operation. The freezing methods promoted the cooling rate and the process of vitrification. The results from Cognie et al. (2003) showed that the kidding rate was 48% and embryo survival rate was 39% by using the vitrification method in goat embryos.

In recent years, researchers have tried to solve the problems resulting in the low survival rate of embryos frozen by vitrification. Vajta et al. (1997) first vitrified bovine embryos in ultra-thin straws with the open pulled straw (OPS) method. The diameter of each ultra-thin straw is half the diameter of a conventional 0.25 mL straw. Successful cryopreservation of bovine embryos with the OPS method increased the cooling rate by 10 times and the cooling rate is approximately 25,000° C./min. Such results assisted the development of OPS methods.

Gayar and Holtz (2001) vitrified goat embryos by the OPS method. The recipients' kidding rate using the OPS method was 93% ( 13/14), and the embryo survival rate was 64% ( 18/28). Since the kidding rate and the embryo survival rate of the conventional slow freezing technique were 58% and 42%, respectively, OPS vitrification is a suitable method for cryopreserving goat embryos The advantage of the OPS vitrification method is the rapid cooling rate. However, the disadvantages of the OPS method include having to pull the straws by hand, the diameter of each pulled straw not being identical, and requiring special staff with particularly skillful techniques to operate the OPS vitrification method.

To prevent the cooling rate from being affected by the biological specimens surrounded with air, the volume of the biological specimens must be limited. Likewise, to increase the cooling rate of vitrification, the volume of the solution must also be limited. Minimum drop vitrification with small amounts of solution is suitable for cell vitrification. Currently, reports show that small volume containers are suitable for vitrification in order to minimize the volume of solution involved. The containers include electron microscopy grids (Park 1 et al., 1999), glass capillaries, close-pulled plastic straws (Chen et al., 2001), cryoloop vitrification (CLV, Lanw elf al., 1999, Yeoman et al., 2001). The containers are made from glass and are convenient for operation after thawing. However, such containers occupy too much space. Other steps are added when using the close-pulled plastic straws to reduce embryo damage during the operation. The disadvantages of the cryoloop vitrification (CLV) method are that a transferred loop must be designed and the CLV method procedure is complex. The embryos are put on the transferred loop and are transferred to a solid surface to form microdrops. Further, the minimum volume cooling procedure uses a commercial microtip to store the embryos. The advantages of such a minimum volume cooling procedure are that the microtip does not have to be pulled by hand and that the diameter of each microtip is identical, but its disadvantage is requiring too much space. (Hochi et al., 2004; Ushijima et al., 2004).

No efficient and convenient cryopreservation method exists for cells, and researchers must establish different procedures for different stages of cells or embryos. Until now, no stable and efficient cryopreservation method for cells has been available, nor does a stable cryopreservation method exist, which has a wide application in cell storage, especially one applicable to current animal reproduction techniques.

To conclude, the conventional cryopreservation-methods for cells still have many disadvantages, such as being expensive and requiring complex apparatus, so the conventional cryopreservation methods are not suitable for doing experiments outdoors. Furthermore, a method is still required that can increase the cooling rate, retain cell viability and be easy to operate. The current invention is particularly useful for freezing cells.

### SUMMARY OF THE INVENTION

An aspect of the present invention relates to a method for vitrification of cells. The method comprises providing cells, culturing the cells in a culture medium containing cryoprotectants for a short period, forming a microdrop from the culture medium containing cells and subjecting the microdrops to liquid nitrogen to obtain glass-like beads.

Preferably, the microdrop is formed on a substrate where the cohesion of the culture medium to the substrate is larger than the surface tension of the culture medium.

Preferably, the cells are from a source of microorganism, plant or animal cells. Preferably, the animal cells are oocytes or animal embryos. More preferably, the animal cells are animal embryos. Most preferably, the animal embryo is at the blastocyst stage.

Preferably, the cells within the culture medium are treated with a two-step cryopreservation method, and the culture medium contains cryoprotectants. More preferably, a first step of the cryopreservation method comprises culturing the cells in a T199 culture medium containing 20% FCS, 10% ethylene glycol and 10% DMSO for 45 seconds. Most preferably, a second step of the cryopreseivation method comprises culturing the cells in a TCM199 culture medium containing 20% FCS, 20% ethylene glycol and 20% DMSO for 25 seconds.

Preferably, the short period of culturing the cells in a culturing medium containing cryoprotectants is less than 5 minutes. More preferably, the short period is less than 2 minutes. Most preferably, the short period is less than 30 seconds.

The microdrop has a volume of 1 to 15 μL. Preferably, the microdrop is of the volume of from 5 to 9 μL. More preferably, the microdrop is of the volume of from 3 to 4 μL. Most preferably, the microdrop is of the volume of from 1 to 2 μL.

Preferably, the substrate is parafilm, wax paper or ester. More preferably, the substrate is parafilm.

Preferably, the microdrop on the microdrop and the substrate are contacted with the liquid nitrogen together.

Preferably, the cells are suspended in the culture medium containing cryoprotectants for a short period.

Preferably, the microdrop containing the cells is directly contacted with the liquid nitrogen to form the glass-like bead.

Further benefits and advantages of the present invention will become apparent after a careful reading of the detailed description.

### DETAILED DESCRIPTION OF THE INVENTION

The present invention relates to a method that has advantages including easy operation, being inexpensive, requiring a simple apparatus, and having a rapid cooling rate for cells cryopreservation. The method according to the present invention provides a short exposure time in cryoprotectants so that the cryoprotectant toxicity can be minimized.

In one aspect, the method according to the present invention relates to vitrification for cells. For the wide application of cryopreservation methods, it is obvious that the survival rate of animal embryos is vitally important. A high survival rate from using the cryopreservation methods will improve the rate of evolution, reproduction efficiency and reduce the breeding cost of livestock. Goat embryos can be vitrified with the method of microdrops vitrification described in the present invention, and the survival rate of the vitrified goat embryos is excellent. Also, the apparatus for the method of microdrops vitrification in the present invention is simple and suitable for outdoor use. Furthermore, the method according to the present invention can be employed at a rapid cooling rate, is easy to perform and is more suitable for high chilling sensitivity of cells, such as in vitro reproduction and embryonic transfer.

The method according to the present invention has the following advantages. (1) In contrast with conventional freezing methods, the method according to the present invention uses parafilm as a transfer carrier and is very convenient and inexpensive. (2) The culture media containing the desired cells in the method described in the present invention comes in direct contact with liquid nitrogen (LN₂), which provides an excellent thermal conducting efficiency to freeze the desired cells. Accordingly, the benefits of the present invention are better and more economical than conventional freezing methods and can be applied widely.

In a preferred embodiment, the method according to the present invention comprises providing cells in a culture medium containing cryoprotectants, and putting the culture medium containing the desired cells on a parafilm to form a microdrop. The volume of each microdrop is in the range of from 1 to 15 μL. Preferably, the volume of each microdrop is in the range of from 5 to 9 μL. More preferably, the volume of each microdrop is in the range of from 3 to 4 μL. Most preferably, the volume of each microdrop is in the range of from 1 to 2 μL. Each microdrop contains from 1 to 20 cells. Preferably, each microdrop contains from 5 to 9 cells. More preferably, each microdrop contains from 2 to 4 cells. In a preferred embodiment, the cells are from microorganisms, plants or animals. Preferably, the cells from animals are oocytes or embryos. More preferably, the embryos are at the blastocyst stage.

The parafilm with the microdrop culture medium is put into a container containing liquid nitrogen (LN₂). The microdrop culture medium is frozen rapidly by using liquid nitrogen to form a glass-like bead. The glass-like beads containing the desired cells were picked up by low temperature forceps. The glass-like beads are collected in a suitable container and stored in a liquid nitrogen storage container until required.

While the following terms are believed to be well understood by those of ordinary skill in the art, the following definitions are set forth to preclude any ambiguity in the explanation of the invention.

The term “cells” as used herein includes any cells from, but not limited to, microorganisms, plants and animals. Oocytes and animal embryos are currently preferred embodiments of the present invention. Animal embryos may come from any desired mammalian sources including, but not limited to, humans; non-human primates, such as monkeys; laboratory mammals, such as rats, mice and hamsters; and farming livestock such as pigs, sheep, cows, goats and horses.

The term “microdrop” as used herein refers to a small drop of a culture medium containing cells that is formed on a substrate capable of making the cohesion of the culture medium larger than the surface tension of the culture medium. The substrate may be selected from the group consisting of parafilm, wax paper and an ester. Parafilm is currently preferred. The volume of each microdrop may be in the range of from 1 to 15 μL. Preferably, the volume of each microdrop may be in the range of from 5 to 9 μL. More preferably, the volume of each microdrop may be in the range of from 3 to 4 μL. Most preferably, the volume of each microdrop may be in the range of from 1 to 2 μL.

The term “glass-like bead” as used herein refers to the microdrop of a culture medium that is formed in a glass-like state by being rapidly frozen.

The term “embryo” as used herein refers to any zygote at an early stage of, but not limited to, morula, gastrula and blastocyst. The blastocyst is currently preferred.

The term “super-ovulated” as used herein refers to a physiological condition of the donor female animal treated with FSH so that an appropriate quantity of mature oocytes can be obtained at the same time.

The term “embryo transfer” as used herein refers to transfer of zygotes inseminated in vivo or in vitro to a recipient female.

The term “vitrification” as used herein refers to the phenomenon that solidification of solution forms (glass formation) at a low temperature without ice crystal formation. This phenomenon can be regarded as an extreme increase of viscosity and requires either rapid cooling rates or the use of cryoprotectant solutions, which decreases ice crystal formation and increases viscosity at low temperatures.

According to the present invention, many advantages are described as follows. The method according to the present invention can be performed in the field because the apparatus used in the present invention can be simply and rapidly operation and the apparatus is inexpensive. Further, an ordinary person skilled in the art will easily learn the method described in the present invention. Cryoprotectants, such as ethylene glycol, polyethylene glycol, dimethylsulfoxide, glycerol, propane diol, sugars, and methyl pentane diol, as well as others will known in the art, can be toxic to sensitive cells such as oocytes and embryos when used in large dosages during cryopreservation. The present invention allows for the use of any optional cryoprotectant to be present in the solution phase in the presence of the biological specimen for shorter time periods than cryopreservation methods previously described in the art. The method for microdrop vitrification of cells according to the present invention reduces time for culturing cells in the medium containing cryoprotectants, and also reduces toxic damage of cells or embryos caused by cryoprotectants.

The low temperature environment contacts the medium containing the desired cells or embryos directly without a straw, and the cooling rate is improved efficiently.

Because the cooling rate is improved (the cooling rate is 15,000 to 30,000° C./min in the present invention), the method according to the present invention avoids ice crystal formation and reduces the damage to the biological specimens caused by crystal formation.

The procedure of the present invention is simple and can be performed smoothly and quickly, such that the biological specimens will not be lost or die during the procedure, and the survival rate of the desired cells will be increased.

This invention is illustrated further by the following non-limiting examples. All of the literature and publications recited in the context of the present disclosure are incorporated herein by reference.

### EXAMPLES

### Example 1

### Method for Vitrification

All chemicals were obtained from Sigma (St. Louis, Mo., USA) and Canadian Life Technologies, Inc. (Burling, Ontario, Canada) except for others as indicated.

### 1.1 Embryo Collection

### 1.1.1 Super-Ovulated

The estrus cycles of female goat donors were synchronized with CIDR® (controlled internal drug release; CIDR, EAZI-BREEDTM, Australia) for 11 days. At the ninth day the female goat donors were treated with 1 mL Prosolvin® (luprostiol 7.5 mg/mL, synthesized prostaglandin F2α, Intervet, Holland) by intramuscular injection and follicle stimulating hormone from porcine pituitary (PFSH, KAWASAKI PHARMACEUTICAL CO, LTD., JAPAN) with decreasing doses at 12-h intervals. The total dose for superovalation was pFSH. 20 A.U. 6 units of luteinizing hormone (LH) from ovine pituitary (Sigma, U.S.A) were administrated for super-ovulating. After estrus cycle began, the female goats were mated with the pure male goats for 2 times at interval of 12 hours until the end of the in-heat period of the female goats.

### 1.1.2 Embryo Collection

Embryos were collected by surgery after the female goat donors came 14 into the seventh day of heat.

### 1.2 Culture Media

### 1.2.1 Frozen Media

TCM-199 culture medium containing 20% FCS

TCM-199 culture medium containing 20% FCS, 10% ethylene glycol and 10% DMSO

TCM-199 culture medium containing 20% FCS, 20% ethylene glycol, 20% DMSO and 0.25 M sucrose

### 1.2.2 Thaw Media

TCM-199 culture medium containing 0.25 M sucrose and 20% FCS

TCM-199 culture medium containing 0.15 M sucrose and 20% FCS

TCM-199 culture medium containing 10% FCS

### 1.3 Process of Vitrification

The collected embryos were vitrified using a two-step freezing process. The collected embryos then were cultured in the TCM-199 culture medium containing 20% FCS for 5 minutes. Firstly, the embryos were transferred to the TCM-199 culture medium containing 20% FCS, 10% ethylene glycol and 10% DMSO for 45 seconds. Secondly, the embryos were transferred to the TCM-199 culture medium containing 20% FCS, 20% ethylene glycol and 0.25 M sucrose for a further 25 seconds.

The embryos cultured in the TCM-199 culture medium containing 20% FCS, 20% ethylene glycol, 20% DMSO and 0.25 M sucrose were contained in a microdrop. Each microdrop (1 to 2 μL) contained 2 to 4 embryos and was transferred to parafilm. The parafilm with the microdrop was put into a container tank of liquid nitrogen (LN₂). The parafilm with the microdrop was then immediately submerged into liquid nitrogen (LN₂)

The microdrop was frozen quickly and formed a glass-like bead. Low temperature forceps were used to pick up the glass-like beads, and the glass-like beads were stored in cryovials.

### Example 2

### Embryo Transfer

### 2.1 Process of Thawing

The embryos were thawed before use. The glass-like beads containing the embryos were thawed in the TCM-199 culture medium containing 0.25 M sucrose and 20% FCS for 10 minutes. Then the embryos were moved to the TCM-199 culture medium containing 0.15 M sucrose and 20% FCS for 5 minutes. Finally, the embryos were moved to the TCM-199 culture medium containing 10% FCS for 5 minutes. Thawed embryos were observed for a few minutes, and survival rate of the embryos was recorded.

### 2.2 Embryo Transfer

### 2.2.1 Synchronization of Estrous Cycle for Female Goat Recipients

The recipients were treated with the same progestagen treatment for 11 days and with intramuscular injections of 1 ml Prosolvin® (Intervet, Holland) and 500 IU pregnant mare's serum gonodotropin (PMSG, CHINA CHEMICAL PHARMACEUTICAL Co., Ltd., Taipei) at the ninth day for inducing synchronization of the estrus cycle.

### 2.2.2 Embryos Transfer

The surviving embryos were transferred directly after flushing to synchronized recipients by laparotomy. Pregnancy percentages and kidding rates were recorded.

### 2.3 Results

In the present invention, seven goat recipients were tested. Five goat recipients became pregnant, and the pregnancy percentage was 5/7 (77%). The kidding rate was 4/7 (57%), and the embryo survival rate was 7/22 (32%). The results of the present invention are similar to Cognie et al. which had results where the reported birth rate was 48% and embryo survival rate was 39%. Table 1 shows the results of fresh embryo transfer. Table 2 shows a comparison of the freezing methods.

TABLE 1
Comparison of fresh embryo transfer

| | | Qty of | Recipients' | | Embryo | |
|---|---|---|---|---|---|---|
| | Qty of Goat | transferred | kidding rates | | survival rate | |
| | recipients (n) | embryos (n) | (%) | No (n) | (%) | No (n) |
| Cognie et | 19 | 38 | 89 | 17 | 71 | 27 |
| al | | | | | | |
| Result of | 52 | 153 | 79 | 41 | 51 | 78 |
| the | | | | | | |
| Present | | | | | | |

TABLE 2
Comparison of the freezing methods

| | Qty of | | | | | |
|---|---|---|---|---|---|---|
| | goat | Qty of | Recipients' | | Embryo | |
| | recipients | transferred | kidding rates | | survival rate | |
| | (n) | embryos (n) | (%) | No. (n) | (%) | No. (n) |
| Conventional | 12 | 24 | 50 | 6 | 42 | 10 |
| freezing | | | | | | |
| method | | | | | | |
| (Gayar and | | | | | | |
| Holtz) | | | | | | |
| Cognie et al. | — | — | 48 | — | 39 | — |
| The present | 7 | 22 | 57 | 4 | 32 | 6 |
| invention | | | | | | |

Although the invention has been explained in relation to its preferred embodiment, many other possible modifications and variations can be made without departing from the spirit and scope of the invention as herein after claimed.

### LITERATURE REFERENCES AND PUBLICATIONS

1. Begin I, Bhatia B, Baldassarre H, Dinnyes A and Keefer CL. 2003. Cryopreservation of goat oocytes and in vivo derived 2- to 4-cell embryos using the cryoloop (CLV) and solid-surface vitrification (SSV) methods. Theriogenology. 59(8):1839-50.
2. Bilton R J and Moore N W. 1976. In vitro culture, storage and transfer of goat embryos. Aust J Biol Sci. Mar.;29(1-2):125-9.
3. Chen S U, Lien Y R, Cheng Y Y, Chen H F, Ho H N and Yang Y S. 2001. Vitrification of mouse oocytes using closed pulled straws (CPS) achieves a high survival and preserves good patterns of meiotic spindles, compared with conventional straws, open pulled straws (OPS) and grids. Hum Reprod. 16(11):2350-6.
4. Cho S K, Cho S G, Bae I H, Park C S and Kong I K. 2002. Improvement in post-thaw viability of in vitro-produced bovine blastocysts vitrified by glass micropipette (GMP). Anim Reprod Sci. 73(3-4):151-8.
5. Cognie Y. Baril G, Poulin N and Mermillod P. 2003. Current status of embryo technologies in sheep and goats. Theriogenology. 59(1): 171-88.
6. Dinnyes A, Dai Y. Jiang S and Yang X. 2000. High developmental rates of vitrified bovine oocytes following parthenogenetic activation, in vitro fertilization, and somatic cell nuclear transfer. Biol Reprod. 63(2):513-8.
7. El-Gayar M and Holtz W. 2001. Technical note: Vitrification of goat embryos by the open pulled-straw method. J Anim Sci. 79(9):2436-8.
8. Huang J C, Yang J R and Hsieh R C. 1997. Effects of diluents and cryoprotectants on cryopreservation of semen and embryos in Taiwan black goat ∘ Taiwan livestock res.30(4) 371-7 ∘
9. Hochi S, Terao T, Kamei M, Kato M, Hirabayashi M and Hirao M. 2004. Successful vitrification of pronuclear-stage rabbit zygotes by minimum volume cooling procedure. Theriogenology. 61(2-3):267-75.
10. Kong I K, Lee S I, Cho S G, Cho S K and Park C S. 2000. Comparison of open pulled straw (OPS) vs glass micropipette (GMP) vitrification in mouse blastocysts. Theriogenology. 53(9): 1817-26.
11. Lane M, Schoolcraft W B and Gardner D K. 1999. Vitrification of mouse and human blastocysts using a novel ciyoloop container-less technique. Fertil Steril. 72(6):1073-8.
12. Matsumoto H, Jiang J Y, Tanaka T, Sasada H and Sato E. 2001. Vitrification of large quantities of immature bovine oocytes using nylon mesh. Cryobiology. 42(2):139-44.
13. Park S P, Kim E Y, Kim D I, Park N H, Won Y S, Yoon S H, Chung K S and Lim J H. 1999. Simple, efficient and successful vitrification of bovine blastocysts using electron microscope grids. Hum Reprod. 14(11):2838-43.
14. Ushijima H, Yoshioka H, Esaki R, Takahashi K, Kuwayama M, Nakane T and Nagashima H.2004. Improved survival of vitrified in vivo-derived porcine embryos. J Reprod Dev. 50(4):481-6.
15. Vajta G, Booth P J, Holm P, Greve T and Callesen H. 1997. Successful vitrification of early stage bovine in vitro produced embryos with the open pulled straw (OPS) methods. Cryoletters 18;191-195.
16. Yeoman R R, Gerami-Naini B, Mitalipov S, Nusser K D, Widmann-Browning A A, and Wolf D P. 2001. Cryoloop vitrification yields superior survival of Rhesus monkey blastocysts. Hum Reprod. 16(9):1965-9.
17. Yuswiati, E. and W. Holtz. 1990. Successful transfer of vitrified goat embryo. Theriogenology 34:629-632.

What is claimed is:

1. A method for microdrop vitrification of cells, comprising:
providing cells;
culturing the cells in a culture medium containing a cryoprotectant for a short period;
forming a microdrop from the culture medium containing the cells; and
contacting the microdrop with liquid nitrogen to obtain a glass-like bead.

2. The method as claimed in claim 1, wherein the microdrop is formed on a substrate that makes the cohesion of the culture medium larger than the surface tension of the culture medium.

3. The method as claimed in claim 1, wherein the cells are from a source of selected from the group consisting of microorganisms, plants and animals.

4. The method as claimed in claim 3, wherein the cells are from animal oocytes or animal embryos.

5. The method as claimed in claim 4, wherein the cells from animal embryos are at the blastocyst stage.

6. The method as claimed in claim 1, wherein the cells culturing the culture medium for a short period comprises treating the cell with a two step procedure.

7. The method as claimed in claim 6, wherein a first step comprises culturing the cells in T199 culture medium containing 20% FCS, 10% ethylene glycol and 10% DMSO for 45 seconds.

8. The method as claimed in claim 6, wherein a second step comprises culturing the cells in T199 culture medium containing 20% FCS, 20% ethylene glycol and 20% DMSO for 25 seconds.

9. The method as claimed in claim 1, wherein the short period is less than 5 minutes.

10. The method as claimed in claim 9, wherein the short period is less than 2 minutes.

11. The method as claimed in claim 10, wherein the short period is less than 30 seconds.

12. The method as claimed in claim 1, wherein the microdrop is of the volume of from 1 to 15 μL.

13. The method as claimed in claim 12, wherein the microdrop is of the volume of from 5 to 9 μL.

14. The method as claimed in claim 13, wherein the microdrop is of the volume of from 3 to 4 μL.

15. The method as claimed in claim 14, wherein the microdrop is of the volume of from 1 to 2 μL.

16. The method as claimed in claim 2, wherein the substrate is selected from the group consisting of parafilm, wax paper and an ester material.

17. The method as claimed in claim 16, wherein the substrate is parafilm.

18. The method as claimed in claim 2, wherein the microdrop on the substrate is directly contacted with liquid nitrogen together with the substrate.

19. The method as claimed in claim 1, wherein the cells are suspended in the culture medium containing a cryoprotectant for a short period.

20. The method as claimed in claim 1, wherein the microdrop containing cells is directly contacted with liquid nitrogen to form the glass-like bead.
